(19) United States
(12) Patent Application Publication
(10) Pub. No.: US 2008/0311872 A1
(43) Pub. Date: Dec. 18, 2008

(54) Broadcast Signal Receiving Apparatus

(75) Inventors: Takeshi Ikeda, Tokyo (JP); Hiroshi Miyagi, Kanagawa (JP)

Correspondence Address: CONNOLLY BOVE LODGE & HUTZ LLP, 1875 EYE STREET, N.W., SUITE 1100, WASHINGTON, DC, 20006, US

(73) Assignee: Neuro Solution Corp., Setagaya-ku, Tokyo (JP)

(21) Appl. No.: 12/280,095

(22) PCT Filed: Sep. 28, 2006
(86) PCT No.: PCT/JP2006/319906

§ 371 Date: Aug. 26, 2008

(30) Foreign Application Priority Data
Feb. 20, 2006 (JP) 2006-042412

(51) Int. Cl. H04B 1/16

(52) U.S. Cl. 455/269; 455/274

(57) ABSTRACT

An LNA (2) is directly connected to a loop antenna (1), and a variable BPF (3), the passed frequency band of which is adapted to be variable, is connected in a stage following the LNA (2). In this way, the variable BPF (3) is used to configure a variable tuning circuit exhibiting a high Q-value without using any impedance conversion transformer between the loop antenna (1) and the LNA (2), whereby almost all of the constituent elements of the tuner part can be integrated in an IC chip (10) and further the variable tuning can maintain an excellent selectivity of a target frequency.

### TECHNICAL FIELD

The present invention relates to a broadcast signal receiving apparatus, and more particularly to an apparatus that receives a broadcast signal using a loop antenna.

### BACKGROUND ART

Examples of antennas used in broadcast signal receiving apparatuses such as a radio receiver include bar antennas and loop antennas. Bar antennas can be miniaturized irrespective of the wavelength of received radio wave, so they are in widespread use for the reception of long wave and medium wave, for example, in an AM radio or wave clock. Since the resonance impedance of bar antenna is large (several hundred KQ), it is combined with a variable-capacitance device to configure a tuning circuit.

Loop antennas are based on the principle that extracts induced electromotive force dependent on the variation in magnetic field in the inner side of a coil formed by turning a conductive wire several times, and are usually connected with a capacitor to be used as a resonance circuit. For example, in a home-use radio receiver, a variable-capacitance capacitor (varactor diode) is used in the resonance circuit, whereby there is configured a variable tuning circuit in which the capacitance value of the varactor diode is varied.

FIG. 4 is a view partially illustrating the configuration of a related art broadcast signal receiving apparatus using a loop antenna. Referring to FIG. 4, reference number 101 denotes a loop antenna; 102 a transformer using a coil; 103 a varactor diode; 104 a capacitor; 105 an LNA (Low Noise Amplifier); 106 a mixer; 107 a local oscillator; 108 an input terminal via which a control voltage is supplied to the varactor diode 103.

Of radio-frequency signals (RF signals) received by means of the loop antenna 101, an RF signal of a tuning frequency obtained by resonating in a resonance circuit which the loop antenna 101 forms along with the varactor diode 103, is impedance-converted by the transformer 102 and supplied to the LNA 105. The RF signal is low-noise amplified by the LNA 105 and supplied to the mixer 106. In the mixer 106, the RF signal is mixed with a local signal from the local oscillator 107 and extracted as an intermediate frequency signal (IF signal).

In this way, in the related art broadcast signal receiving apparatus using the loop antenna 101, the transformer 102 and varactor diode 103 are used for impedance conversion. The reason for the impedance conversion is that the loop antenna 101 has a low impedance (several hundred Ω) and thus the tuning effect is small when the loop antenna 101 is used as it is, so impedance matching with the variable-capacitance device must be achieved.

However, the transformer 102 and varactor diode 103 are difficult to be integrated in an IC chip and thus must be configured as external components of the IC chip. Consequently, the mounting of the transformer 102 and varactor diode 103 constitutes a limiting factor in the miniaturization of the broadcast signal receiving apparatus.

Meanwhile, there has been provided a communication apparatus in which an LNA is arranged closest to a reception antenna, and a band-pass filter (BPF) is connected in a stage following the LNA (for example, refer to Patent Document 1). In the communication apparatus of this type, a signal is received by means of the reception antenna, amplified by the LNA and then supplied to the BPF. The BPF allows passage of only a signal of a predetermined frequency band with a center frequency at a reception frequency.

Patent Document 1: Japanese Patent Laid-Open No. 11

### DISCLOSURE OF THE INVENTION

However, in the related art as described in Patent Document 1, there is used no variable tuning circuit using a varactor diode and thus the passed frequency band of the BPF must be set to cover the whole reception frequency band of AM broadcasting. Accordingly, the selectivity of a target frequency (the capability of eliminating an interfering signal of another frequency when the interfering signal is applied while a signal of a target frequency is received) is low, resulting in a problem of being susceptible to interferences. Further, when the LNA is arranged closest to the reception antenna to omit a transformer, impedance conversion by the transformer cannot be implemented, so impedance matching is difficult to achieve.

The present invention has been devised to address the above problem, and has an object to provide a broadcast signal receiving apparatus that does not use any transformer and varactor diode, so that integration in an IC chip is easy to implement, and further has an excellent selectivity of a target frequency.

Another object of the present invention is to allow easy impedance matching.

To address the above problem, in the broadcast signal receiving apparatus according to the present invention, an LNA is arranged closest to a loop antenna, and a variable band-pass filter, for which the passed frequency band is adapted to be variable, is connected in a stage following the LNA.

According to another aspect of the present invention, the gate of a MOS transistor acting as an amplifying device of the LNA is connected to a ground terminal.

According to the present invention having the above configuration, the variable band-pass filter is used so that a variable tuning circuit exhibiting a high Q-value is configured without using any transformer and varactor diode, and thus the integration in an IC chip is easily performed and further the selectivity of a target frequency is made excellent.

According to another feature of the present invention, the impedance as seen from the loop antenna side to the IC chip side is equal to the reciprocal of a conductance of the MOS transistor and thus is simplified, so that impedance matching can be easily achieved.

### BRIEF DESCRIPTION OF THE DRAWINGS

FIG. 1 is a view illustrating an exemplary configuration of the main part of a broadcast signal receiving apparatus according to the present embodiment;

FIG. 2 is a view illustrating an exemplary configuration of a variable BPF according to the present embodiment;

FIG. 3 is a view illustrating an exemplary configuration of an LNA according to the present embodiment; and

FIG. 4 is a view partially illustrating the configuration of a related art broadcast signal receiving apparatus using a loop antenna.

### BEST MODE FOR CARRYING OUT THE INVENTION

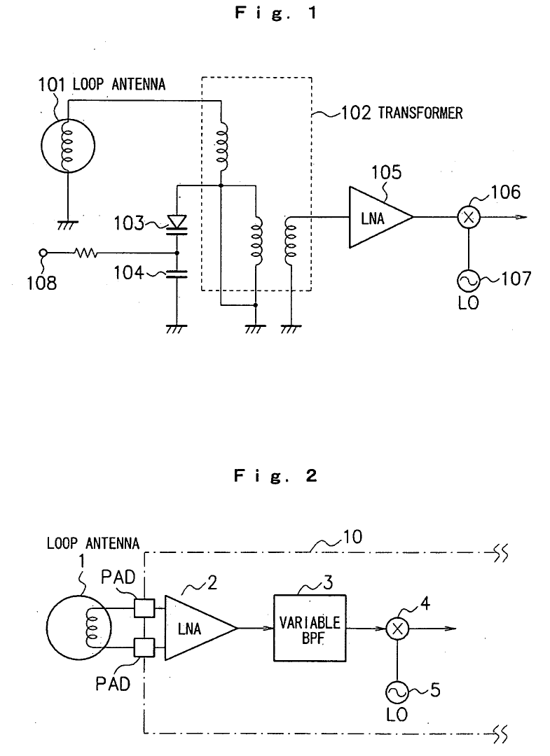

Embodiments of the present invention will be described below with reference to the drawings. FIG. 1 is a view illustrating an exemplary configuration of the main part of a broadcast signal receiving apparatus according to the present embodiment. As described in FIG. 1, the broadcast signal receiving apparatus according to the present embodiment includes a loop antenna 1, LNA (low noise amplifier) 2 directly connected to the loop antenna 1, variable BPF 3, mixer 4 and local oscillator 5. Of these components, the LNA 2, variable BPF 3, mixer 4 and local oscillator 5 are integrated in a single IC chip 10 by means of a process such as CMOS (Complementary Metal Oxide Semiconductor) or Bi-CMOS (Bipolar-CMOS).

The variable BPF 3 is connected in a stage following the LNA 2, and the passed frequency band thereof is adapted to be variable. According to the present embodiment, the variable BPF 3 is an active filter for which the passed frequency band can be controlled by a resistance value and capacitance value. Typically, a large quantity of noise is produced in active filters; thus when the level of an input signal is low, a high S/N ratio cannot be achieved. Meanwhile, only a small quantity of noise is produced in the LNA 2, so an excellent S/N ratio is achieved. Accordingly, when the signal level is preliminarily low-noise amplified by the LNA 2 and then inputted to the variable BPF 3, the S/N ratio in the variable BPF 3 can be improved.

FIG. 2 is a view illustrating an exemplary configuration of the variable BPF 3 according to the present embodiment. As illustrated in FIG. 2, the variable BPF 3 according to the present embodiment is a two-amplifier type filter circuit (DABP: Dual-Amplifier Bandpass Filter) including two operational amplifiers OA1 and OA2, for which a high Q-value can be achieved. According to the present embodiment, resistors constituting this DABP are each constituted of multiple resistance elements, and the connection between the resistance elements can be changed by means of a switch.

More specifically, as illustrated in FIG. 2, a resistor R1 is constituted of N-number (N being an integer of two or more) of resistance elements R₁₁, R₁₂, . . . , R_{1N} connected in series. The resistance elements R₁₁, R₁₂, . . . , R_{1N} may have the same resistance value or may have different values. Similarly, a resistor R2 is constituted of N-number of resistance elements R₂₁, R₂₂, . . . , R_{2N} connected in series. The resistance elements R₂₁, R₂₂, . . . , R_{2N} may have the same resistance value or may have different values.

A resistor R3 is also constituted of N-number of resistance elements R₃₁, R₃₂, . . . , R_{3N} connected in series. The resistance elements R₃₁, R₃₂, . . . , R_{3N} may have the same resistance value or may have different values. However, R₂₁=R₃₁, R₂₂=R₃₂, . . . , R_{2N}=R_{3N}.

Reference characters S₁₁, S₁₂, . . . , S_{1N-1} denote (N−1)-number of switches used to perform selection from N-number of resistance elements R₁₁, R₁₂, . . . , R_{1N}; reference characters S₂₁, S₂₂, . . . , S_{2N-1} denote (N−1)-number of switches used to perform selection from N-number of resistance elements R₂₁, R₂₂, . . . , R_{2N}; and reference characters S₃₁, S₃₂, . . . , S_{3N-1} denote (N−1)-number of switches used to perform selection from N-number of resistance elements R₃₁, R₃₂, . . . , R_{3N}.

The multiple resistance elements R₁₁, R₁₂, . . . , R_{1N} and multiple switches S₁₁, S₁₂, . . . , S_{1N-1} are ladder-connected; when one of the switches is turned on, resistance elements to be connected in series are selected. For example, when the first switch S₁₁ is turned on, the first resistance element R₁₁ is short-circuited and the second and subsequent resistance elements R₁₂, . . . , R₁N are connected in series.

Similarly, the multiple resistance elements R₂₁, R₂₂, . . . , R_{2N} and multiple switches S₂₁, S₂₂, . . . , S_{2N-1} are ladder-connected; when one of the switches is turned on, resistance elements to be connected in series are selected. For example, when the first switch S₂₁ is turned on, the first resistance element R₂₁ is short-circuited and the second and subsequent resistance elements R₂₂, . . . , R_{2N} are connected in series.

Similarly, the multiple resistance elements R₃₁, R₃₂, . . . , R_{3N} and multiple switches S₃₁, S₃₂, . . . , S_{3N-1} are ladder-connected; when one of the switches is turned on, resistance elements to be connected in series are selected. For example, when the first switch S₃₁ is turned on, the first resistance element R₃₁ is short-circuited and the second and subsequent resistance elements R₃₂, . . . , R_{3N} are connected in series.

Here, of the multiple switches S₂₁, S₂₂, . . . , S_{2N-1} for the resistor R2 and the multiple switches S₃₁, S₃₂, . . . , S_{3N-1} for the resistor R3, the i-th (i=1 to N−1) switches are turned on in synchronization with each other. That is, the resistors R2 and R3 are made to have the same resistance value at all times. However, of the multiple switches S₁₁, S₁₂, . . . , S_{1N-1} for the resistor R1, the i-th switches don't always need to be turned on in synchronization with each other with respect to the switches S₂₁, S₂₂, . . . , S_{2N-1} for the resistor R2 and the switches S₃₁, S₃₂, . . . , S_{3N-1} for the resistor R3.

In the variable BPF 3 having the above configuration, one set of switches among S₁ⱼ, S₂ᵢ and S₃ᵢ are turned on (i≠j or i=j), whereby the resistance values of the resistors R1, R2 and R3 connected to the operational amplifiers OA1 and OA2 can be varied.

The resistor R1 is used to vary the Q-value, and the resistors R2 and R3 are used to vary the tuning frequency. The Q-value of the variable BPF 3 is determined based on the capacitance value of the capacitor C1 and a combination resistance value obtained by connecting in series, resistance elements selected from among the multiple resistance elements R₁₁, R₁₂, . . . , R_{1N} by means of the switches S₁₁, S₁₂, . . . , S_{1N-1}. The tuning frequency (resonance frequency) of the variable BPF 3 is determined based on the capacitance value of the capacitor C2 and a combination resistance value obtained by connecting in series, resistance elements selected from among the multiple resistance elements R₂₁, R₂₂, . . . , R_{2N}, R₃₁, R₃₂, R_{3N} by means of the switches S₂₁, S₂₂, . . . , S_{2N-1}, S₃₁, S₃₂, S_{3N-1}.

The switches S₁₁, S₁₂, . . . , S_{1N-1}, S₂₁, S₂₂, . . . , S_{2N-1}, S₃₁, S₃₂, . . . , S_{3N-1} are controlled by a DSP (Digital Signal Processor) (not illustrated), for example. More specifically, the DSP performs switch selection according to a target frequency set by user (frequency that has been set as a broadcast signal reception channel), so that switches selected from among the switches S₁₁, S₁₂, S_{1N-1}, S₂₁, S₂₂, . . . , S_{2N-1}, S₃₁, S₃₂, . . . , S_{3N-1} are turned on.

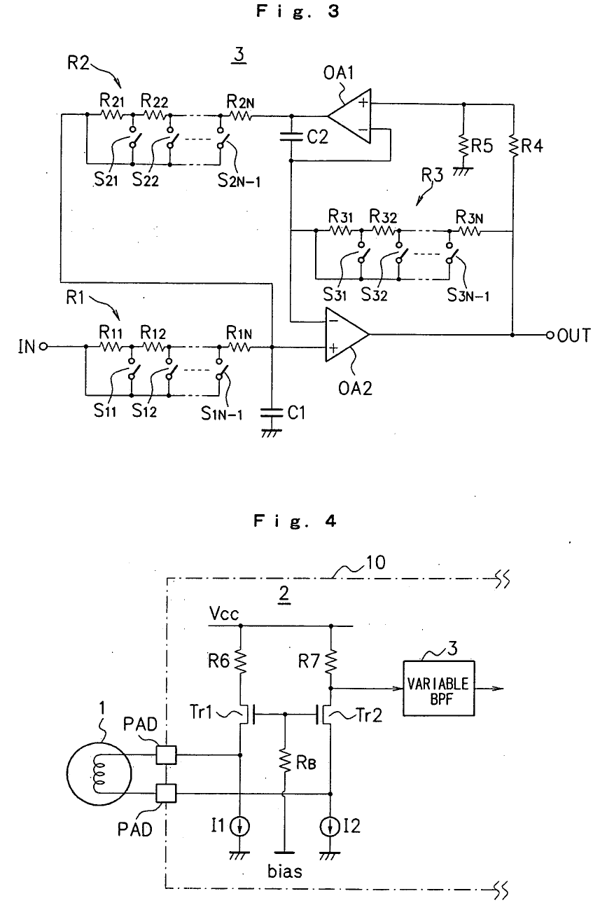

FIG. 3 is a view illustrating an exemplary configuration of the LNA 2 according to the present embodiment. As illustrated in FIG. 3, the LNA 2 according to the present embodiment includes two MOS transistors (for example, n-channel MOSFET (field-effect transistor)) Tr1 and Tr2 which are amplifying devices, two resistors R6 and R7 connected between the MOS transistors Tr1 and Tr2 and a power line Vcc, two constant current sources 11 and 12 connected between the MOS transistors Tr1 and Tr2 and a ground terminal, and a bias resistor RB. The gates of the MOS transistors Tr1 and Tr2 are both connected via the bias resistor RB to the ground terminal.

In this way, when the MOS transistors Tr1 and Tr2 of the LNA 2 have the grounded-gate configuration, input impedance Zᵢₙ of the IC chip 10 (impedance as seen from the loop antenna 1 side to the IC chip 10 side) is equal to the reciprocal of conductance gₘ of the MOS transistors Tr1 and Tr2 and thus is simplified (Zᵢₙ=1/gₘ). According to the present embodiment, the MOS transistors Tr1 and Tr2 are each constituted of, for example, an FET fabricated in CMOS process and thus conductance gₘ is small, so that input impedance Zᵢₙ is large. Accordingly, when conductance gₘ is set to an appropriate value by adjusting bias resistor RB, the impedance matching with the loop antenna 1 (conversion of a low impedance of the loop antenna 1 to an appropriately high impedance) can be easily achieved.

As described above in detail, according to the present embodiment, the impedance matching can be properly achieved and a variable tuning circuit exhibiting a high Q-value can be configured by using the variable BPF 3, without placing any transformer for impedance conversion and any varactor diode for tuning between the loop antenna 1 and the LNA 2. As a result, the external components of the IC chip 10 in the signal receiving unit can be almost only the loop antenna 1 while achieving faborable selectivity of a target frequency. Note that, the DSP (not illustrated) can be integrated in the same IC chip 10.

In the present embodiment, there is described the case where selection is performed from the multiple resistance elements R₁₁, R₁₂, . . . , R_{1N}, R₂₁, R₂₂, . . . , R_{2N}, R₃₁, R₃₂, . . . , R_{3N} to vary the resistance value, so that the tuning frequency and the Q-value of the variable BPF 3 is varied. However, the present invention is not limited thereto. For example, a configuration may be used in which each of the capacitors C1 and C2 is constituted of multiple capacitance elements, and selection is performed from these by means of a switch to vary the capacitance value, so that the tuning frequency and the Q-value of the variable BPF 3 is varied.

In the present embodiment, there is described the case where the variable BPF 3 is constituted of a two-amplifier type band-pass filter (DABP). However, the present invention is not limited thereto. For example, there may be used a configuration in which the resistor being a constituent element of a Sallen-Key type, multi-loop feedback type, state variable type, bi-quadratic type or differential-input type band-pass filter, or another type of band-pass filter is constituted of multiple resistance elements, so that selection can be performed from these resistance elements by means of a switch, or a configuration in which the capacitor being a constituent element of above type band-pass filter is constituted of multiple capacitance elements, so that selection can be performed from these capacitance elements by means of a switch.

Further, according to the present embodiment, the resistor R1 is constituted of multiple resistance elements R₁₁, R₁₂, . . . , R_{1N}, and selection is performed from these by means of the switches S₁₁, S₁₂, . . . , S_{1N}, and the resistors R2 and R3 are constituted of multiple resistance elements R₂₁, R₂₂, . . . , R_{2N-1}, and R₃₁, R₃₂, . . . , R_{3N}, respectively, and selection is performed from these by means of the switches S₂₁, S₂₂, . . . , and S_{2N-1}, S₃₁, S₃₂, S_{3N-1}. However, all of the resistors R1, R2 and R3 don't need to be constituted of multiple resistance elements. For example, the resistor R1 used to vary the Q-value may have a fixed resistance value.

In the present embodiment, there is described the case where n-channel MOSFET is used as the amplifying transistor of the LNA 2. However, p-channel MOSFET may be used. The use of p-channel MOSFET is advantageous in that flicker noise can be reduced more effectively.

The above-described embodiments are merely of an example for implementing the invention, and the technical scope of the invention should not be restrictively interpreted by the description of the embodiments. That is, many modifications to the embodiments described above are possible without departing from the spirit and gist of the invention.

### INDUSTRIAL APPLICABILITY

The present invention is useful for a broadcast signal receiving apparatus such as an AM radio receiver which receives a broadcast signal by means of a loop antenna.

1. A broadcast signal receiving apparatus comprising:
a loop antenna;
a low noise amplifier which is connected to the loop antenna; and
a variable band-pass filter which is connected to the low noise amplifier and for which the passed frequency band is adapted to be variable,
the low noise amplifier and the variable band-pass filter are integrated in the same semiconductor chip.

2. The broadcast signal receiving apparatus according to claim 1,
the variable band-pass filter is an active filter.

3. The broadcast signal receiving apparatus according to claim 2,
the variable band-pass filter is a filter circuit in which:
a resistor being a constituent element of the filter circuit is constituted of a plurality of resistance elements;
there is included switches used to perform selection from the plurality of resistance elements; and
the tuning frequency is determined based on a capacitance value of capacitor and a resistance value of a resistance element selected from among the plurality of resistance elements by means of the switches.

4. The broadcast signal receiving apparatus according to claim 2,
the variable band-pass filter is a filter circuit in which:
a capacitor being a constituent element of the filter circuit is constituted of a plurality of capacitance elements;
there is included switches used to perform selection from the plurality of capacitance elements; and
the tuning frequency is determined based on a resistance value of resistor and a capacitance value of a capacitance element selected from among the plurality of capacitance elements by means of the switches.

5. The broadcast signal receiving apparatus according to claim 1,
the low noise amplifier includes a MOS transistor acting as an amplifying device with a gate which is connected to a ground terminal.

6. The broadcast signal receiving apparatus according to claim 1,
the low noise amplifier and the variable band-pass filter are configured in CMOS process.
